(19) United States
(12) Patent Application Publication
(10) Pub. No.: US 2012/0117325 A1
(43) Pub. Date: May 10, 2012

(54) METHOD AND DEVICE FOR PROCESSING DATA CACHING

(75) Inventors: Hongqi Chen, Shenzhen City (CN); Chang Zhou, Shenzhen City (CN)

(73) Assignee: ZTE Corporation, Shenzhen City (CN)

(21) Appl. No.: 13/383,498

(22) PCT Filed: May 21, 2010
(86) PCT No.: PCT/CN2010/073072

§ 371 Date: Jan. 11, 2012

(30) Foreign Application Priority Data
Jul. 24, 2009 (CN) 200910161519.7

(51) Int. Cl. G06F 12/00

(52) U.S. Cl. 711/118; 711/E12.001

(57) ABSTRACT

The present invention discloses a method and device for processing data caching, wherein the method includes: storing cached data into a memory; after reading out the cached data from a memory space address for storing the cached data in the memory, judging whether the cached data that have been read out are the same as the cached data to be written before the storing, if so, then deciding that the memory space for storing the cached data in the memory is normal; if not, then deciding that the memory space for storing the cached data in the memory is abnormal; and when the cached data is stored during the subsequent data caching process, storing the cached data only into the memory spaces in normal state in the memory.

### TECHNICAL FIELD

The present invention relates to the technical field of network communication, and in particular, to a method and device for processing data caching.

### BACKGROUND ART

When data are cached in a route switching device, as shown in FIG. 1, a data caching control module 101 usually splits a data packet into a plurality of data slices according to a certain rule and stores them in a memory 102, and when the data packet is output, it then combines the plurality of split data slices into the original data packet. The length of the split data slice of the data packet should be associated with factors such as the minimum length of the data packet, inner packet processing speed, and data bit width of the memory. Queue storage usually adopts a dynamic storage mode with different queue storage regions, and under the condition of considering the bandwidth utilization ratio of a dynamic memory, the queue data needing to be cached may be put in any idle region at any moment.

With the development of network technology, the capacity of dynamic data caching in the route switching device becomes larger and larger, and the reliability of data caching becomes a problem that has to be considered. The typical processing mode is to improve the fault-tolerance ability of data caching through an Error correction code (ECC), i.e., when data are received, an ECC is generated for each data slice, and when the data are output, each data slice is corrected according to the ECC of the data slice and then output in order to improve the reliability of data caching. However, the ECC achieves the fault-tolerance ability by adding redundant data, and the lengths of redundant data for different ECC algorithms are different, as are the lengths of data slices in different application scenes. The segmentation of data slices must be segmenting the addresses of the data slices integrally, and the addition of the different lengths of the redundant data may cause complicity of data address generation and addressing. Therefore, the mode of adding redundant data is generally not taken into consideration when caching data in a route switching device.

### SUMMARY OF THE INVENTION

The technical problem to be solved in the present invention is to provide a method and device for processing data caching to detect whether an unsafe memory space exits in the memory, thereby improving the reliability of data caching.

In order to solve the above technical problem, the present invention provides a device for processing data caching, comprising a data caching control module connected with a memory, wherein the data caching control module is configured to cache received data in the memory, and read out the data cached in the memory after completing caching, and the device further comprises a data detecting module connected with the data caching control module.

The data caching control module is further configured to provide cached data to be written and a memory space address for storing the cached data in the memory for the data detecting module before writing the cached data into the memory, and after reading out the cached data from the memory space address of the memory, provide the cached data that have been read out for the data detecting module. The data caching control module is further configured to acquire from the data detecting module normal or abnormal state of a memory space in the memory, and store subsequent cached data only into normal memory spaces.

The data detecting module is configured to judge whether the cached data that have been read out are the same as the cached data to be written, and if so, decide that the memory space in the memory for storing the cached data is normal; if not, decide that the memory space in the memory for storing the cached data is abnormal.

Preferably, the data detecting module comprises a data input control unit, a storage unit and a data output control unit that are connected in sequence.

The data input control unit is configured to, after obtaining from the data caching control module the cached data to be written, generate first check data according to the cached data to be written and store the first check data in the storage unit. The data input control unit is further configured to, after obtaining the cached data that have been read out from the data caching control module, generate second check data according to the cached data that have been read out, and when the first check data are judged to be the same as the second check data, decide that the memory space in the memory for storing the cached data is normal; when the first check data are judged to be different from the second check data, decide that the memory space in the memory for storing the cached data is abnormal, and store the normal or abnormal state of the memory space in the memory for storing the cached data in the storage unit.

The data output control unit is configured to obtain the normal or abnormal state of the memory space in the memory for storing the cached data from the storage unit, and inform the data caching control module of the state of the memory space.

Preferably, the data detecting module comprises a data input control unit, a storage unit and a data output control unit that are connected in sequence.

The data input control unit is configured to, after obtaining the cached data to be written from the data caching control module, store the cached data to be written into the storage unit; the data input control unit is further configured to, after obtaining the cached data that have been read out from the data caching control module, compare the cached data that have been read out with the stored cached data to be written, when the cached data that have been read out are the same as the stored cached data to be written, decide that the memory space in the memory for storing the cached data is normal; when the cached data that have been read out are different from the stored cached data to be written, decide that the memory space in the memory for storing the cached data is abnormal, and store the normal or abnormal state of the memory space in the memory for storing the cached data in the storage unit.

The data output control unit is configured to obtain the normal or abnormal state of the memory space in the memory for storing the cached data from the storage unit, and inform the data caching control module of the state of the memory space.

Preferably, the data detecting module comprises a data input control unit, a storage unit and a data output control unit that are connected in sequence.

The data input control unit is configured to, after obtaining from the data caching control module the cached data to be written, generate first check data according to the cached data to be written and store the first check data in the storage unit.

The data output control unit is configured to, after obtaining the cached data that have been read out from the data caching control module, generate second check data according to the cached data that have been read out, obtain the first check data from the storage unit, and when the first check data are judged to be the same as the second check data, decide that the memory space in the memory for storing the cached data is normal; when the first check data are judged to be different from the second check data, decide that the memory space in the memory for storing the cached data is abnormal, and store the normal or abnormal state of the memory space in the memory for storing the cached data in the storage unit.

The data caching control module is further configured to acquire the normal or abnormal state of the memory is in normal or abnormal state by reading the storage unit.

Preferably, the data detecting module comprises a data input control unit, a storage unit and a data output control unit that are connected in sequence.

The data input control unit is configured to, after obtaining from the data caching control module the cached data to be written, generate first check data according to the cached data to be written and send the first check data to the data caching control module.

The data output control unit is configured to obtain the cached data that have been read out and the corresponding first check data from the data caching control module, generate second check data according to the cached data that have been read out, and when the first check data are judged to be the same as the second check data, decide that the memory space in the memory for storing the cached data is normal; when the first check data are judged to be different from the second check data, decide that the memory space in the memory for storing the cached data is abnormal, and store the normal or abnormal state of the memory space in the memory for storing the cached data in the storage unit.

The data caching control module is further configured to receive the first check data sent by the data input control unit, and store both the cached data to be written and the first check data in the memory; and acquire the normal or abnormal state of the memory space in the memory by reading the storage unit.

Preferably, the storage unit is configured to maintain a memory mapping table, wherein composition elements of the memory mapping table correspond to memory space segments of the memory one by one, and each of the composition elements represents a state of a corresponding memory space segment.

The data input control unit is further configured to, after deciding the state of a memory space segment, write the state of the memory space segment into the memory mapping table. The data output control unit is further configured to provide the memory mapping table to the data caching control module.

Preferably, the space occupied by the composition element of the memory mapping table is one bit, and the capacity of the memory space segment corresponding to each composition element of the memory mapping table is the same.

Preferably, the device is applied to a route switching device.

In order to solve the above technical problem, the present invention provides a method for processing data caching, comprising the following steps of:

storing cached data into a memory;

after reading out the cached data from a memory space address for storing the cached data in the memory, judging whether the cached data that have been read out are the same as the cached data to be written before the storing; if so, then deciding that the memory space in the memory for storing the cached data is normal; if not, then deciding that the memory space in the memory for storing the cached data is abnormal; and

when storing cached data during a subsequent data caching process, storing the cached data only into memory spaces in normal state in the memory.

Preferably, in the step of judging whether the cached data that have been read out are the same as the cached data to be written before the storing, whether the cached data that have been read out are the same as the cached data to be written before the storing is judged by way of judging check data.

Preferably, before the step of storing cached data into a memory, the method further comprises: generating first check data according to the cached data to be written before the storing and storing the first check data;

after reading out the cached data from the memory space address for storing the cached data in the memory, the method further comprises: generating second check data according to the cached data that have been read out;

in the step of judging whether the cached data that have been read out are the same as the cached data to be written before the storing, whether the cached data that have been read out are the same as the cached data to be written before the storing is judged by judging whether the first check data are the same as the second check data.

Preferably, before the step of storing cached data into a memory, the method further comprises: generating first check data according to the cached data to be written before the storing;

the step of storing cached data into a memory comprises: storing both the cached data to be written and the first check data into the memory;

in the step of reading out the cached data, the cached data and the corresponding first check data are read out;

after the step of reading out the cached data, the method further comprises: generating second check data according to the cached data that have been read out;

in the step of judging whether the cached data that have been read out are the same as the cached data to be written before the storing, whether the cached data that have been read out are the same as the cached data to be written before the storing is judged by judging whether the first check data are the same as the second check data.

Preferably, the method further comprises:

storing a normal or abnormal state of the memory space for storing the cached data;

wherein, the state of the memory space in the memory is recorded by maintaining a memory mapping table, composition elements of the memory mapping table correspond to memory space segments of the memory one by one, and each of the composition elements represents a state of a corresponding memory space segment; the judged state of the memory space segment is written into the memory mapping table.

Preferably, the space occupied by the composition element of the memory mapping table is one bit, and the capacity of the memory space segment corresponding to each composition element of the memory mapping table is the same.

Compared with the existing ECC technology for improving fault-tolerance ability, the present invention can be implemented with simple code migration and may be directly applied to an existing device for data caching to detect whether an unsafe memory space exists in the memory, thus improving the reliability of data caching.

### BRIEF DESCRIPTION OF THE DRAWINGS

FIG. 1 is a structural diagram of the modules of the route switching device for data caching implemented in the related art.

FIG. 2 is a structural diagram of the modules of the device for processing data caching according to an example of the present invention.

FIG. 3 is a structural diagram of the specific composition of the data detecting module according to an example of the present invention.

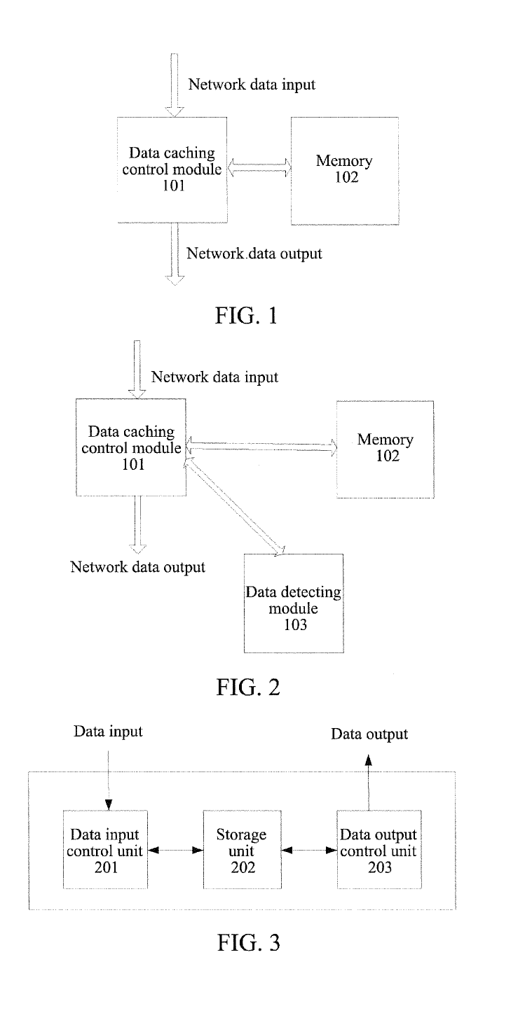

### PREFERRED EMBODIMENTS OF THE INVENTION

As shown in FIG. 2, the device for processing data caching comprises a data caching control module 101 and a memory 102 connected with the data caching control module 101, and further comprises a data detecting module 103 connected with the data caching control module 101.

The data caching control module 101 is configured to cache received data in the memory 102, and read out the data cached in the memory after completing caching, and it is further configured to provide cached data to be written and a memory space address for storing the cached data in the memory for the data detecting module before writing the cached data into the memory. It is further configured to, after reading out the cached data from the memory space address of the memory, provide the cached data that have been read out for the data detecting module; the data caching control module is further configured to acquire from the data detecting module normal or abnormal state of a memory space in the memory, and store cached data only into normal memory spaces and isolate the abnormal memory spaces.

The data detecting module 103 is configured to judge whether the cached data that have been read out are the same as the cached data to be written; and if so, decide that the memory space in the memory for storing the cached data is normal; if not, decide that the memory space in the memory for storing the cached data is abnormal, and inform the data caching control module of the normal or abnormal state of the memory space in the memory.

As shown in FIG. 3, the data detecting module 103 comprises a data input control unit 201, a storage unit 202 and a data output control unit 203 that are connected in sequence.

The data input control unit 201 is configured to, after obtaining from the data caching control module the cached data to be written, generate first check data according to the cached data to be written and store the first check data in the storage unit; after obtaining the cached data that have been read out from the data caching control module, generate second check data according to the cached data that have been read out; when the first check data are judged to be the same as the second check data, decide that the memory space in the memory for storing the cached data is normal; when the first check data are judged to be different from the second check data, decide that the memory space in the memory for storing the cached data is abnormal, and store the normal or abnormal state of the memory space in the memory for storing the cached data in the storage unit; or, obtain from the data caching control module the cached data to be written and store the cached data to be written into the storage unit; after obtaining the cached data that have been read out from the data caching control module, when the cached data that have been read out are the same as the stored cached data to be written, decide that the memory space in the memory for storing the cached data is normal; when the cached data that have been read out are different from the stored cached data to be written, decide that the memory space in the memory for storing the cached data is abnormal.

The data output control unit 203 is configured to obtain the normal or abnormal state of the memory space in the memory for storing the cached data from the storage unit, and inform the data caching control module of the state of the memory space.

The storage unit 202 is configured to maintain a memory mapping table, wherein composition elements of the memory mapping table correspond to memory space segments of the memory one by one, the space occupied by the composition element of the memory mapping table is one bit (for example, when the bit value is 1, it indicates that the memory space segment corresponding to this composition element is normal, and when the bit value is 0, it indicates that the memory space segment corresponding to this composition element is abnormal). The capacity of the memory space segment corresponding to each composition element of the memory mapping table may be the same or not, and in order to facilitate implementation of the storing flow, the capacity of the memory space segment is generally configured to be the same (for example 1K bits for all segments). The storage unit 202 initializes the memory mapping table when the device is started up, and it is defaulted that every memory space address is in normal state. After deciding the state of a memory space segment, the data input control unit 201 writes the state of the memory space segment into the memory mapping table; the data output control unit 203 provides the memory mapping table to the data caching control module 101, and the data caching control module 101, when storing new cached data, inquires this memory mapping table such that the data are stored only in the memory spaces marked as normal.

The above technical scheme may also be implemented in the following various ways:

the data input control unit 201, after obtaining from the data caching control module the cached data to be written, generates the first check data according to the cached data to be written and sends the first check data to the data caching control module 101, and the data caching control module 101 stores both the cached data to be written and the first check data into the memory 102; the data output control unit 203, after obtaining the cached data that have been read out and corresponding first check data from the data caching control module 101, generates second check data according to the cached data that have been read out, and if it is judged that the first check data are the same as the second check data, decides that the memory space in the memory for storing the cached data is normal; if it is judged that the first check data are different form the second check data, decides that the memory space in the memory for storing the cached data is abnormal, and stores the normal or abnormal state of the memory space in the memory for storing the cached data in the storage unit 202;

or, the data input control unit 201, after obtaining from the data caching control module 101 the cached data to be written, generates the first check data according to the cached data to be written and stores the first check data into the storage unit 202; the data output control unit 203, after obtaining the cached data that have been read out from the data caching control module 101, generates the second check data according to the cached data that have been read out, and obtains the first check data from the storage unit 202, and if it is judged that the first check data are the same as the second check data, decide that the memory space in the memory for storing the cached data is normal; if it is judged that the first check data are different from the second check data, decide that the memory space in the memory for storing the cached data is abnormal, and store the normal or abnormal state of the memory space in the memory for storing the cached data in the storage unit 202;

or, the data input control unit 201 obtains the cached data to be written from the data caching control module 101 and stores the cached data to be written into the storage unit 202; the data output control unit 203, after obtaining the cached data that have been read out from the data caching control module 101, compare the cached data that have been read out with the stored cached data to be written, if the cached data that have been read out are the same as the stored cached data to be written, decides that the memory space in the memory for storing the cached data is normal; if the cached data that have been read out are different from the stored cached data to be written, decides that the memory space in the memory for storing the cached data is abnormal, and stores the normal or abnormal state of the memory space in the memory for storing the cached data in the storage unit 202;

or, the data input control unit 201, after obtaining from the data caching control module 101 the cached data to be written, generates the first check data according to the cached data to be written and stores the first check data in the storage unit 202; the data output control unit 203, after obtaining the cached data that have been read out from the data caching control module 101, generates the second check data according to the cached data that have been read out; then the data input control unit 201, if judging that the first check data are the same as the second check data, decides that the memory space in the memory for storing the cached data is normal;

if judging that the first check data are different from the second check data, decides that the memory space in the memory for storing the cached data is abnormal, and stores the normal or abnormal state of the memory space in the memory for storing the cached data in the storage unit 202.

The data caching control module 101 may be configured to acquire the normal or abnormal state of the memory space in the memory by reading the storage unit 202.

In the above device, the physical storage areas are marked by creating a mapping link table of data slices, the written data are copied, and the stored data are verified when the data are read out, the error data slices are isolated, whether an unsafe memory space (i.e., a memory space that may cause a data storage error due to hardware) exists in the memory can be quickly detected, and the reliability is improved by reducing the error rate of data caching. Compared with the ECC fault-tolerance method in the related art, the present invention does not need to generate redundant data, and can facilitate management of memory space addresses in the memory and is easy to implement.

The method according to the example of the present invention comprises: storing cached data into a memory; after reading out the cached data from a memory space address for storing the cached data in the memory, judging whether the cached data that have been read out are the same as the cached data to be written before the storing, if so, then deciding that the memory space for storing the cached data in the memory is normal; if not, then deciding that the memory space for storing the cached data in the memory is abnormal; and when the cached data is stored during the subsequent data caching process, storing the cached data only into the memory spaces in normal state in the memory.

Specifically, the method for improving the reliability of data caching in a memory by using the device shown in FIG. 2 and FIG. 3 comprises the following steps:

step 1, starting the device after powering on or reset;

step 2, the data input control module 201 writing the initialization values of the mapping link table into the mapping table automatically, and storing them into the storage unit 202, wherein, the values of all composition elements of the mapping table are set to be 1 initially to indicate that every memory space of the memory is normal;

step 3, the device turning on the detection state of the memory;

step 4, before the data caching control module 101 writes the cached data into the memory 102, the data input control module 201 acquiring from the data caching control module 101 the cached data to be written and the memory space address in the memory for storing the cached data, and generating first check data according to the cached data to be written and storing the first check data in the storage unit 202; in this step, the method for generating check data according to the cached data to be written is not defined in the present invention, and a person skilled in the art may adopt any method for generating check data with which he is familiar;

step 5, the data caching control module 101 storing the cached data in the memory 102;

step 6, when the data caching control module 101 needs to read out the cached data from the memory, the data output control module 203 obtaining from the data caching control module 101 the cached data that have been read out and the memory space address in the memory for storing the cached data, and generating second check data according to the cached data that have been read out;

step 7, the data input control module 201 judging whether the first check data corresponding to the memory space address are the same with the second check data; if not, marking the value of the composition element corresponding to the memory space address in the memory for storing the cached data to be 0 in the mapping table of the memory to indicate that this memory space is abnormal, and informing the data caching control module 101 of the updated memory mapping table; if they are the same, not marking the memory mapping table;

step 8, in subsequent data caching operation, the data caching control module 101 storing data only into the memory space addresses indicated by the composition elements whose values are 1 in the memory mapping table.

In the above method, the mode of storing the generated first check data into an external memory (since generally the data width of an external memory is slightly larger than that of the data in the data slices) and directly comparing the generated second check data with the first check data that have been read out from the memory may also be adopted, i.e., after the first check data are generated, the cached data to be written and the corresponding first check data are both stored in the memory; when reading the data, the cached data and the corresponding first check data are read out, second check data are generated according to the cached data that have been read out, and then whether the first check data and the second check data are the same is judged so as to judge whether the cached data that have been read out and the cached data to be written before storing are the same or not.

Specifically, in the above step 4, the data input control module 201 generates the first check data according to the cached data to be written and sends them to the data caching control module 101;

in step 5, the data caching control module 101 stores the cached data and the first check data in the memory 102;

in step 6, the data output control module 203 obtains the cached data that have been read out, the corresponding first check data and the memory space address in the memory for storing the cached data from the data caching control module 101, and generates the second check data according to the cached data that have been read out;

in step 7, the data output control module 203 judges whether the first check data corresponding to the memory space address are the same with the second check data, and if not, the value of the composition element corresponding to the memory space address in the memory for storing the cached data is marked to be 0 in the mapping table of the memory to indicate that this memory space is abnormal; if yes, the memory mapping table is not marked.

Other steps are the same with those described above.

The above method can conveniently detect whether an unsafe memory space exists in the memory, and further improve the reliability of data caching. Moreover, the present invention is applicable to a hardware that involves a large amount of data dynamic caching and data splitting processing and requires reliability of data caching, and is typically applicable to a route switching device.

Although the present invention is described with reference to specific examples, modifications and variations can be made to the present invention without departing from the spirit or scope of the present invention for a person skilled in the art. Such modifications and variations are regarded as within the scope of the present invention and the scope of the attached claims.

### INDUSTRIAL APPLICABILITY

The method and device for processing data caching provided in the present invention can be implemented with simple code migration and may be directly applied to an existing device for data caching to detect whether an unsafe memory space exists in the memory, thus improving the reliability of data caching.

1. A device for processing data caching, comprising a data caching control module connected with a memory, wherein the data caching control module is configured to cache received data in the memory, and read out the data cached in the memory after completing caching, and the device further comprises a data detecting module connected with the data caching control module;
the data caching control module is further configured to provide cached data to be written and a memory space address for storing the cached data in the memory for the data detecting module before writing the cached data into the memory; after reading out the cached data from the memory space address of the memory, provide the cached data that have been read out for the data detecting module; the data caching control module is further configured to acquire from the data detecting module normal or abnormal state of a memory space in the memory, and store subsequent cached data only into normal memory spaces;
the data detecting module is configured to judge whether the cached data that have been read out are the same as the cached data to be written, and if so, decide that the memory space in the memory for storing the cached data is normal; if not, decide that the memory space in the memory for storing the cached data is abnormal.

2. The device according to claim 1, wherein,
the data detecting module comprises a data input control unit, a storage unit and a data output control unit that are connected in sequence;
the data input control unit is configured to, after obtaining from the data caching control module the cached data to be written, generate first check data according to the cached data to be written and store the first check data in the storage unit; the data input control unit is further configured to, after obtaining the cached data that have been read out from the data caching control module, generate second check data according to the cached data that have been read out, and when the first check data are judged to be the same as the second check data, decide that the memory space in the memory for storing the cached data is normal; when the first check data are judged to be different from the second check data, decide that the memory space in the memory for storing the cached data is abnormal, and store the normal or abnormal state of the memory space in the memory for storing the cached data in the storage unit;
the data output control unit is configured to obtain the normal or abnormal state of the memory space in the memory for storing the cached data from the storage unit, and inform the data caching control module of the state of the memory space.

3. The device according to claim 1, wherein,
the data detecting module comprises a data input control unit, a storage unit and a data output control unit that are connected in sequence;
the data input control unit is configured to, after obtaining the cached data to be written from the data caching control module, store the cached data to be written into the storage unit; the data input control unit is further configured to, after obtaining the cached data that have been read out from the data caching control module, compare the cached data that have been read out with the stored cached data to be written, when the cached data that have been read out are the same as the stored cached data to be written, decide that the memory space in the memory for storing the cached data is normal; when the cached data that have been read out are different from the stored cached data to be written, decide that the memory space in the memory for storing the cached data is abnormal, and store the normal or abnormal state of the memory space in the memory for storing the cached data in the storage unit;
the data output control unit is configured to obtain the normal or abnormal state of the memory space in the memory for storing the cached data from the storage unit, and inform the data caching control module of the state of the memory space.

4. The device according to claim 1, wherein,
the data detecting module comprises a data input control unit, a storage unit and a data output control unit that are connected in sequence;
the data input control unit is configured to, after obtaining from the data caching control module the cached data to be written, generate first check data according to the cached data to be written and store the first check data in the storage unit;
the data output control unit is configured to, after obtaining the cached data that have been read out from the data caching control module, generate second check data according to the cached data that have been read out, obtain the first check data from the storage unit, and when the first check data are judged to be the same as the second check data, decide that the memory space in the memory for storing the cached data is normal; when the first check data are judged to be different from the second check data, decide that the memory space in the memory for storing the cached data is abnormal, and store the normal or abnormal state of the memory space in the memory for storing the cached data in the storage unit;
the data caching control module is further configured to acquire the normal or abnormal state of the memory space in the memory by reading the storage unit.

5. The device according to claim 1, wherein,
the data detecting module comprises a data input control unit, a storage unit and a data output control unit that are connected in sequence;
the data input control unit is configured to, after obtaining from the data caching control module the cached data to be written, generate first check data according to the cached data to be written and send the first check data to the data caching control module;
the data output control unit is configured to, obtain the cached data that have been read out and the corresponding first check data from the data caching control module, generate second check data according to the cached data that have been read out, and when the first check data are judged to be the same as the second check data, decide that the memory space in the memory for storing the cached data is normal; when the first check data are judged to be different from the second check data, decide that the memory space in the memory for storing the cached data is abnormal, and store the normal or abnormal state of the memory space in the memory for storing the cached data in the storage unit;
the data caching control module is further configured to receive the first check data sent by the data input control unit, and store both the cached data to be written and the first check data in the memory; and acquire the normal or abnormal state of the memory space in the memory by reading the storage unit.

6. The device according to claim 2, wherein,
the storage unit is configured to maintain a memory mapping table, wherein composition elements of the memory mapping table correspond to memory space segments of the memory one by one, and each of the composition elements represents a state of a corresponding memory space segment;
the data input control unit is further configured to, after deciding the state of a memory space segment, write the state of the memory space segment into the memory mapping table;
the data output control unit is further configured to provide the memory mapping table to the data caching control module.

7. The device according to claim 6, wherein,
the space occupied by the composition element of the memory mapping table is one bit, and the capacity of the memory space segment corresponding to each composition element of the memory mapping table is the same.

8. The device according to claim 6, wherein,
the device is applied to a route switching device.

9. A method for processing data caching, comprising following steps of:
storing cached data into a memory;
after reading out the cached data from a memory space address for storing the cached data in the memory, judging whether the cached data that have been read out are the same as the cached data to be written before the storing, if so, then deciding that the memory space in the memory for storing the cached data is normal; if not, then deciding that the memory space in the memory for storing the cached data is abnormal; and
when storing cached data during a subsequent data caching process, storing the cached data only into memory spaces in normal state in the memory.

10. The method according to claim 9, wherein,
in the step of judging whether the cached data that have been read out are the same as the cached data to be written before the storing, whether the cached data that have been read out are the same as the cached data to be written before the storing is judged by way of judging check data.

11. The method according to claim 10, wherein,
before the step of storing cached data into a memory, the method further comprises: generating first check data according to the cached data to be written before the storing and storing the first check data;
after reading out the cached data from the memory space address for storing the cached data in the memory, the method further comprises: generating second check data according to the cached data that have been read out;
in the step of judging whether the cached data that have been read out are the same as the cached data to be written before the storing, whether the cached data that have been read out are the same as the cached data to be written before the storing is judged by judging whether the first check data are the same as the second check data.

12. The method according to claim 10, wherein,
before the step of storing cached data into a memory, the method further comprises: generating first check data according to the cached data to be written before the storing;
the step of storing cached data into a memory comprises: storing both the cached data to be written and the first check data into the memory;
in the step of reading out the cached data, the cached data and the corresponding first check data are read out;
after the step of reading out the cached data, the method further comprises: generating second check data according to the cached data that have been read out;
in the step of judging whether the cached data that have been read out are the same as the cached data to be written before the storing, whether the cached data that have been read out are the same as the cached data to be written before the storing is judged by judging whether the first check data are the same as the second check data.

13. The method according to claim 9, further comprising:
storing a normal or abnormal state of the memory space for storing the cached data;
wherein, the state of the memory space in the memory is recorded by maintaining a memory mapping table, composition elements of the memory mapping table correspond to memory space segments of the memory one by one, and each of the composition elements represents a state of a corresponding memory space segment; the judged state of the memory space segment is written into the memory mapping table.

14. The method according to claim 13, wherein,
the space occupied by the composition element of the memory mapping table is one bit, and the capacity of the memory space segment corresponding to each composition element of the memory mapping table is the same.

15. The device according to claim 3, wherein,
the storage unit is configured to maintain a memory mapping table, wherein composition elements of the memory mapping table correspond to memory space segments of the memory one by one, and each of the composition elements represents a state of a corresponding memory space segment;
the data input control unit is further configured to, after deciding the state of a memory space segment, write the state of the memory space segment into the memory mapping table;
the data output control unit is further configured to provide the memory mapping table to the data caching control module.

16. The device according to claim 15, wherein,
the space occupied by the composition element of the memory mapping table is one bit, and the capacity of the memory space segment corresponding to each composition element of the memory mapping table is the same.

17. The device according to claim 4, wherein,
the storage unit is configured to maintain a memory mapping table, wherein composition elements of the memory mapping table correspond to memory space segments of the memory one by one, and each of the composition elements represents a state of a corresponding memory space segment;
the data input control unit is further configured to, after deciding the state of a memory space segment, write the state of the memory space segment into the memory mapping table;
the data output control unit is further configured to provide the memory mapping table to the data caching control module.

18. The device according to claim 17, wherein,
the space occupied by the composition element of the memory mapping table is one bit, and the capacity of the memory space segment corresponding to each composition element of the memory mapping table is the same.

19. The device according to claim 5, wherein,
the storage unit is configured to maintain a memory mapping table, wherein composition elements of the memory mapping table correspond to memory space segments of the memory one by one, and each of the composition elements represents a state of a corresponding memory space segment;
the data input control unit is further configured to, after deciding the state of a memory space segment, write the state of the memory space segment into the memory mapping table;
the data output control unit is further configured to provide the memory mapping table to the data caching control module.

20. The device according to claim 19, wherein,
the space occupied by the composition element of the memory mapping table is one bit, and the capacity of the memory space segment corresponding to each composition element of the memory mapping table is the same.
